(19) United States
(12) Patent Application Publication
(10) Pub. No.: US 2021/0374652 A1
(43) Pub. Date: Dec. 2, 2021

(54) STORAGE MEDIUM, JOB SCHEDULING DEVICE, AND JOB SCHEDULING METHOD

(71) Applicant: FUJITSU LIMITED, Kawasaki-shi (JP)

(72) Inventor: Shigeto SUZUKI, Kawasaki (JP)

(73) Assignee: FUJITSU LIMITED, Kawasaki-shi (JP)

(21) Appl. No.: 17/216,734

(22) Filed: Mar. 30, 2021

(30) Foreign Application Priority Data
Jun. 2, 2020 (JP) 2020-096121

(51) Int. Cl. G06Q 10/06; G06F 1/28

(52) U.S. Cl. CPC G06Q 10/063114; G06F 1/28

(57) ABSTRACT

A job scheduling method executed by a computer, the method comprising: identifying a first power consumption needed to execute a plurality of first jobs executed in a past and a plurality of nodes used to execute the plurality of first jobs; identifying a second power consumption needed for each of the plurality of nodes used to execute the plurality of first jobs to execute a job, based on the first power consumption and the plurality of nodes; identifying a first node of which the second power consumption is greater than a predetermined threshold value, from among the plurality of nodes; identifying a third job in which a number of nodes used for execution is equal to or greater than a number of the first nodes, from among a plurality of second jobs to be executed; and setting a timing of executing the third job to a predetermined time.

### CROSS-REFERENCE TO RELATED APPLICATION

This application is based upon and claims the benefit of priority of the prior Japanese Patent Application No. 2020-96121, filed on Jun. 2, 2020, the entire contents of which are incorporated herein by reference.

### FIELD

The embodiments discussed herein are related to a storage medium, a job scheduling device, and a job scheduling method.

### BACKGROUND

For example, a business operator that provides a service to a user (hereinafter, also simply referred to as a business operator) constructs a business system expected for providing the service. Then, the business operator causes a job scheduler that designates, for example, the execution time of each job to work in such a business system.

In detail, for example, when a new job is submitted, the job scheduler specifies a node that can execute the new job, based on information on a job execution status or the like of each node. Then, in this case, the job scheduler instructs one of the specified nodes to execute the new job. Japanese Laid-open Patent Publication No. 2013-092951 and the like are known as related art.

### SUMMARY

According to an aspect of the embodiments, a job scheduling method executed by a computer, the method comprising: Identifying a first power consumption needed to execute a plurality of first jobs executed in a past and a plurality of nodes used to execute the plurality of first jobs; identifying a second power consumption needed for each of the plurality of nodes used to execute the plurality of first jobs to execute a job, based on the first power consumption and the plurality of nodes; Identifying a first node of which the second power consumption is greater than a predetermined threshold value, from among the plurality of nodes; identifying a third job in which a number of nodes used for execution is equal to or greater than a number of the first nodes, from among a plurality of second jobs to be executed; and setting a timing of executing the third job to a predetermined time.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining the configuration of an information processing system 10;

FIG. 2 is a diagram for explaining a specific example of scheduling respective jobs;

FIG. 3 is a diagram for explaining a specific example of scheduling respective jobs;

FIG. 4 is a diagram for explaining a specific example of scheduling respective jobs;

FIG. 5 is a diagram for explaining a specific example of scheduling respective jobs;

FIG. 6 is a diagram for explaining a specific example of scheduling respective jobs;

FIG. 7 is a diagram explaining a specific example of transition prediction of power consumption of a job execution device 3;

FIGS. 8A and 88 are diagrams for explaining a specific example of scheduling respective jobs;

FIG. 9 is a diagram explaining a specific example of transition prediction of power consumption of the job execution device 3;

FIG. 10 is a diagram for explaining a specific example of scheduling respective jobs;

FIG. 11 is a diagram explaining a hardware configuration of an information processing device 1;

FIG. 12 is a block diagram of the functions of the information processing device 1;

FIG. 13 is a flowchart diagram explaining an outline of a job scheduling process according to a first embodiment;

FIG. 14 is a flowchart diagram explaining details of the job scheduling process according to the first embodiment;

FIG. 15 is a flowchart diagram explaining details of the job scheduling process according to the first embodiment;

FIG. 16 is a flowchart diagram explaining details of the job scheduling process according to the first embodiment;

FIG. 17 is a flowchart diagram explaining details of the job scheduling process according to the first embodiment;

FIG. 18 is a flowchart diagram explaining details of the job scheduling process according to the first embodiment;

FIG. 19 is a flowchart diagram explaining details of the job scheduling process according to the first embodiment;

FIG. 20 is a flowchart diagram explaining details of the job scheduling process according to the first embodiment;

FIG. 21 is a flowchart diagram explaining details of the job scheduling process according to the first embodiment;

FIG. 22 is a diagram explaining a specific example of power consumption information 131;

FIG. 23 is a diagram explaining a specific example of average power consumption information 131a;

FIG. 24 is a diagram explaining a specific example of group information 131b;

FIG. 25 is a diagram explaining a specific example of maximum power consumption information 131c;

FIG. 26 is a diagram explaining details of the job scheduling process according to the first embodiment;

FIG. 27 is a diagram explaining a specific example of reserved job information 134;

FIG. 28 is a diagram explaining a specific example of execution status information 133;

FIG. 29 is a diagram explaining a specific example of schedule information 135; and

FIG. 30 is a diagram explaining details of the job scheduling process according to the first embodiment.

### DESCRIPTION OF EMBODIMENTS

Here, for example, when each job is executed in a large-scale high performance computing (HPC) system or the like, the temperature of a building in which the HPC system is deployed rises with the execution of each job. Therefore, in this case, a worker who executes the job (hereinafter, also simply referred to as a worker) needs to activate the air conditioning equipment (temperature cooling equipment) for lowering the temperature inside the building.

In this regard, the air conditioning equipment as described above sometimes consumes a large amount of electric power depending on the scale and the like of the HPC system. Furthermore, there is a time lag between when the setting of the air conditioning equipment as described above is made and when the temperature inside the building is actually lowered. For this reason, the worker generates a control schedule for the air conditioning equipment (for example, a schedule in regard to a timing of changing the temperature inside the building) in advance, for example, based on the execution timing of each job scheduled by a job scheduler. Then, the worker controls the air conditioning equipment in accordance with the control schedule generated in advance.

This makes it easier for the worker to efficiently suppress the temperature rise inside the building while suppressing the power consumption expected for the activation of the air conditioning equipment.

However, there are cases where the execution of each job is completed earlier than the execution timing of each job scheduled by the job scheduler. Then, in this case, the execution timing of a job executed after a job whose execution is completed earlier is advanced earlier than originally planned. Therefore, the worker is sometimes hindered in controlling the air conditioning equipment at a proper timing even when the control schedule for the air conditioning equipment is followed.

In view of the above, it is desirable to properly control the air conditioning equipment.

[Configuration of information Processing System]

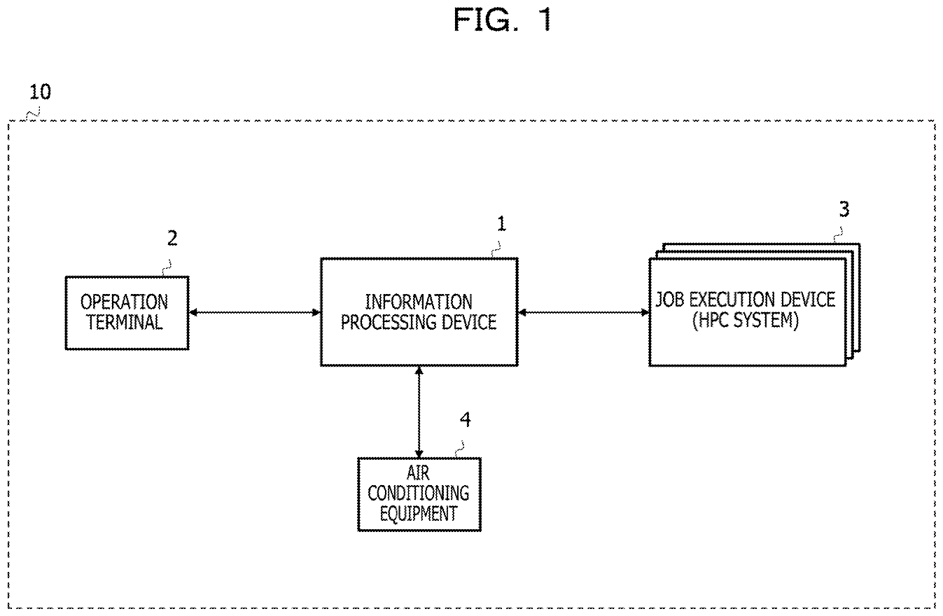

First, a configuration of an information processing system 10 will be described. FIG. 1 is a diagram explaining a configuration of the information processing system 10.

The Information processing system 10 includes an information processing device 1 in which a job scheduler that schedules job execution timing works, and an operation terminal 2 on which a worker performs relevant operations. Furthermore, the information processing system 10 includes a job execution device 3 that executes a job in accordance with a schedule made by the information processing device 1, and air conditioning equipment 4 that adjusts the temperature inside a building (not illustrated) in which the job execution device 3 is deployed.

The job execution device 3 is a device constituted by a plurality of nodes (a plurality of physical machines), and is, for example, an HPC system. Furthermore, the operation terminal 2 is a terminal capable of accessing the information processing device 1 via a network (not illustrated) such as the Internet.

In detail, the worker inputs, for example, a job to be executed to the information processing device 1 via the operation terminal 2. Furthermore, the worker inputs, for example, the number of nodes used for job execution and the execution time of each job to the information processing device 1 via the operation terminal 2.

Then, the information processing device 1 transmits the job to be executed, which has been input from the operation terminal 2, to the job execution device 3. Furthermore, the information processing device 1 generates information (hereinafter, also referred to as schedule information) Indicating the schedule of the execution timing of the job to be executed, based on each piece of information input from the operation terminal 2, and transmits the generated information to the job execution device 3.

Thereafter, the job execution device 3 executes the job to be executed by following the schedule information transmitted from the information processing device 1. The job scheduling performed in the information processing device 1 will be described below.

[Specific Example of Job Scheduling]

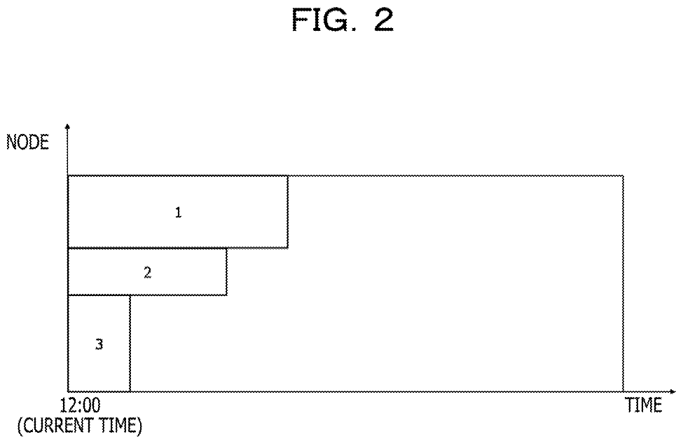

FIGS. 2 to 6, 8A and 8B, and 10 are diagrams for explaining specific examples of job scheduling. Note that the horizontal axis and the vertical axis in the examples illustrated in FIG. 2 and other figures indicate the time when each job is executed and the execution node of each job, respectively. Furthermore, in the examples illustrated in FIG. 2 and other figures, the length of the horizontal axis of a rectangle corresponding to each job corresponds to the turnaround time of each job. Hereinafter, the explanation will be given assuming that the current time is 12:00.

When scheduling jobs, for example, the information processing device 1 performs scheduling such that a job having a priority of “1” (hereinafter, also referred to as a job 1), a job having a priority of “2” (hereinafter, also referred to as a job 2), and a job having a priority of “3” (hereinafter, also referred to as a job 3) are executed at the same time, as illustrated in FIG. 2. This means that the information processing device 1 performs scheduling such that as many jobs as possible are executed in parallel in the order from the highest priority job.

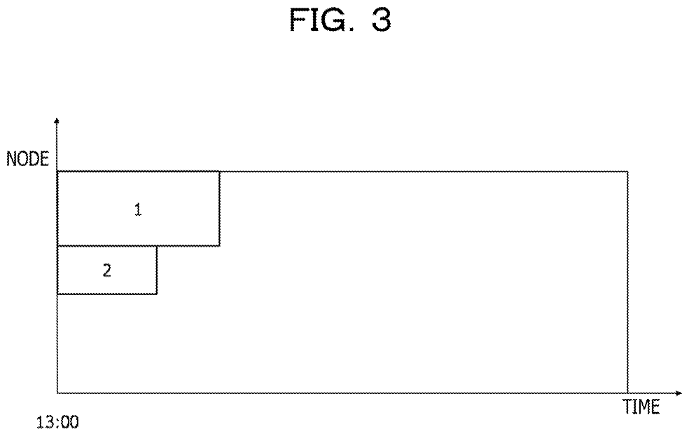

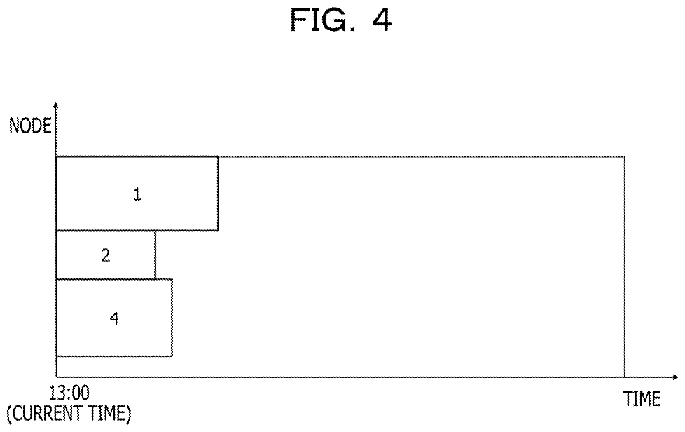

Then, for example, as illustrated in FIG. 3, when a free node is produced because of the end of execution of the job 3 at the time point when one hour has passed (13:00), for example, the information processing device 1 performs scheduling such that a job having a priority of “4” (hereinafter, also referred to as a job 4) is executed on the free node that has been produced, as illustrated in FIG. 4. This means that, in this case, the information processing device 1 performs scheduling such that the job 4, which is the highest priority job among unexecuted jobs, is executed.

This enables the information processing device 1 to schedule the execution timing of each job such that the jobs are executed in the order from the highest priority.

Here, in the job scheduling described with reference to FIGS. 2 to 4, for example, when a large number of jobs are submitted at the same time, jobs other than jobs being executed (hereinafter, also referred to as jobs waiting to be executed) are not scheduled. Therefore, in this case, the worker has a difficulty in grasping the turnaround time of the jobs waiting to be executed.

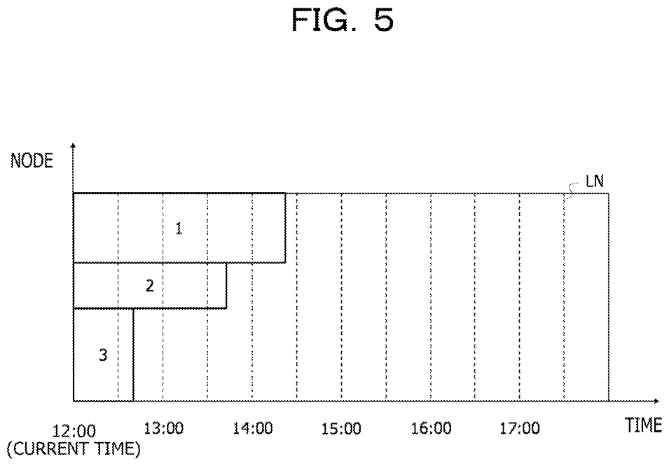

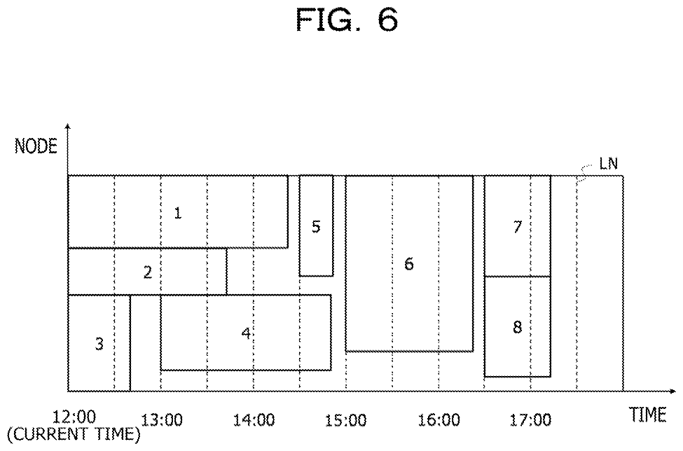

Thus, for example, as illustrated in FIG. 5, the information processing device 1 splits the time after the current time into predetermined time bands (hereinafter, also referred to as sections). Then, for example, as illustrated in FIG. 6, the information processing device 1 schedules the jobs waiting to be executed, assuming that each job is to be started from the time corresponding to a split line LN of each section.

In detail, for example, as illustrated in FIG. 6, the information processing device 1 performs scheduling such that the execution of the job 4 is to be started from the split line LN subsequent to the execution end time (predicted execution end time) of the job 3. Furthermore, the information processing device 1 performs scheduling such that, for example, the execution of a job having a priority of “5” (hereinafter, also referred to as a job 5) is to be started from the split line LN subsequent to the execution end time of the job 1.

Moreover, the information processing device 1 performs scheduling such that, for example, the execution of a job having a priority of “6” (hereinafter, also referred to as a job 6) is to be started from the split line LN subsequent to the execution end times of the jobs 4 and 5, as illustrated in FIG. 6. In addition, the information processing device 1 performs scheduling such that, for example, the execution of a job having a priority of “7” (hereinafter, also referred to as a job 7) and a job having a priority of “8” (hereinafter, also referred to as a job 8) is to be started from the split line LN subsequent to the execution end time of the job 6.

This enables the information processing device 1 to schedule not only jobs that are immediately executed or jobs being executed, but also jobs waiting to be executed. Therefore, the information processing device 1 is enabled to visualize the turnaround time of each job. Accordingly, the worker is allowed to grasp the turnaround time of each job by referring to the information illustrated in FIG. 6, for example.

Next, the air conditioning equipment 4 illustrated in FIG. 1 will be described.

When jobs are executed in the job execution device 3 as described above, the temperature of the building in which the job execution device 3 is deployed rises due to the heat generated from the job execution device 3. Therefore, the worker needs to activate the air conditioning equipment (cooling equipment) 4 for lowering the temperature inside the building.

In this regard, the air conditioning equipment 4 sometimes consumes a large amount of electric power depending on the scale and the like of the job execution device 3. Furthermore, there is a time lag between when the setting of the air conditioning equipment 4 is made and when the temperature inside the building is actually lowered. For this reason, the information processing device 1 generates a control schedule for the air conditioning equipment 4 (for example, a schedule in regard to a timing of changing the temperature inside the building) in advance, for example, based on the execution timing of each job scheduled by the job scheduler. Then, the information processing device 1 controls the air conditioning equipment in accordance with the control schedule generated in advance.

This enables the information processing device 1 to efficiently suppress the temperature rise inside the building while suppressing the power consumption expected for the activation of the air conditioning equipment 4. The control schedule for the air conditioning equipment 4 will be described below.

[Schedule for Air Conditioning Equipment]

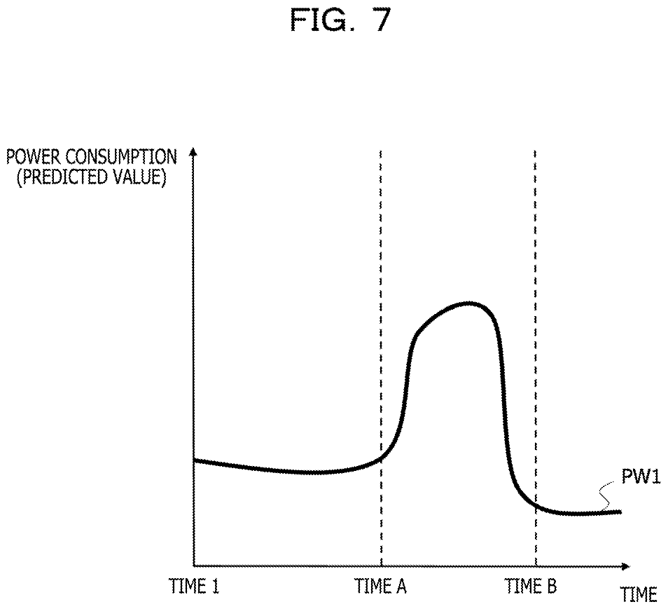

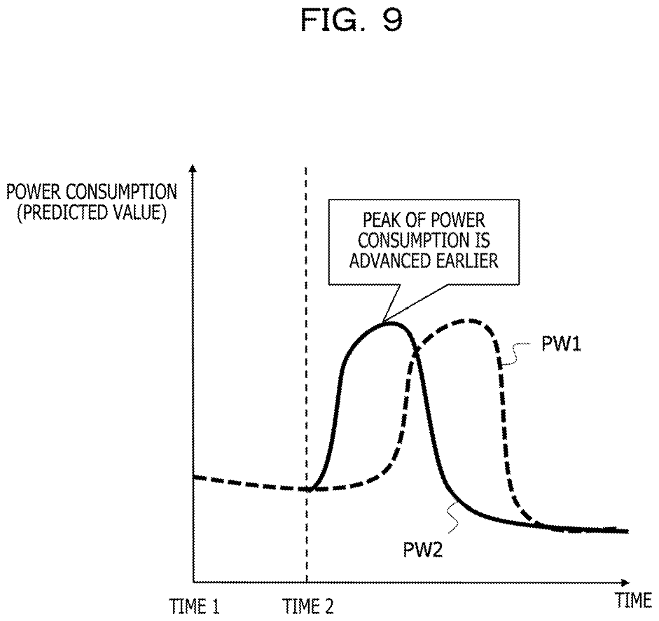

FIGS. 7 to 9 are diagrams explaining the schedule for the air conditioning equipment 4. For example, FIGS. 7 and 9 are diagrams explaining specific examples of transition prediction of power consumption of the job execution device 3. Note that the horizontal axis and the vertical axis in the examples illustrated in FIG. 7 and other figures indicate the time when each job is executed and the power consumption of the job execution device 3, respectively.

Time-series data PW1 illustrated in FIG. 7 is time-series data PW1 of the power consumption of the job execution device 3 generated in accordance with the execution timing of each job scheduled at time 1 by the information processing device 1.

For example, in the example illustrated in FIG. 7, the amount of power consumption in the time band between time A and time B is greater than the power consumption in the other time bands. Therefore, the information processing device 1 designates the control schedule for the air conditioning equipment 4 such that, for example, the temperature inside the building in the time band between the time A and the time B becomes lower than the temperature in the other time bands.

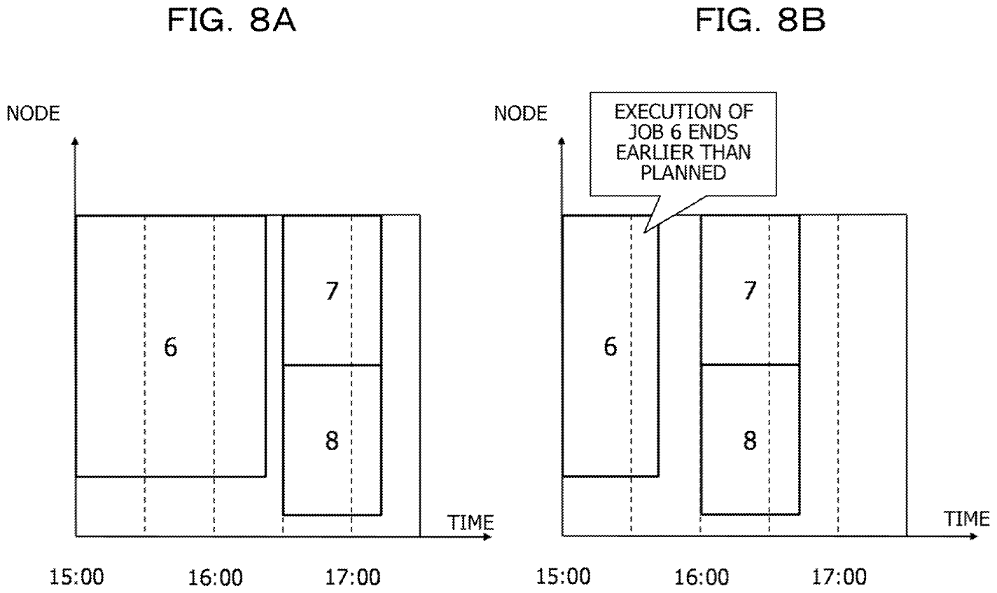

Here, as illustrated in FIGS. 8A and 88, there are cases where the execution of each job is completed earlier than the execution timing of each job scheduled by the job scheduler.

In detail, for example, even when the execution of the job 6 is scheduled to continue until later than 16:00 as illustrated in FIG. 8A, actually, for example, the execution ends before 16:00 in some cases, as illustrated in FIG. 8B.

Then, in this case, the job execution device 3 is allowed to start the execution of the jobs 7 and 8 from a time earlier than 16:30, which is the originally planned time. Therefore, for example, the information processing device 1 reschedules the execution timing of the jobs 7 and 8 according to the end of execution of the job 6, and alters the start time of the execution of the jobs 7 and 8 to 16:00, as illustrated in FIG. 88.

This enables the information processing device 1 to efficiently execute each job in the job execution device 3.

However, the alteration of the execution timing of each job by rescheduling as described above also affects the transition prediction of the power consumption of the job execution device 3.

In detail, for example, the peak value of the power consumption in time-series data PW2 generated in accordance with the execution timing of each job rescheduled at time 2 is advanced earlier than the peak value of the power consumption in the time-series data PW1, as illustrated in FIG. 9.

Furthermore, as described earlier, there is a time lag between when the setting of the air conditioning equipment 4 is made and when the temperature inside the building is lowered.

Therefore, the information processing device 1 is sometimes not allowed to alter the control schedule for the air conditioning equipment 4 even when the execution timing of each job has been rescheduled after the control schedule for the air conditioning equipment 4 was designated.

Accordingly, in some cases, the worker is hindered in controlling the air conditioning equipment at a proper timing.

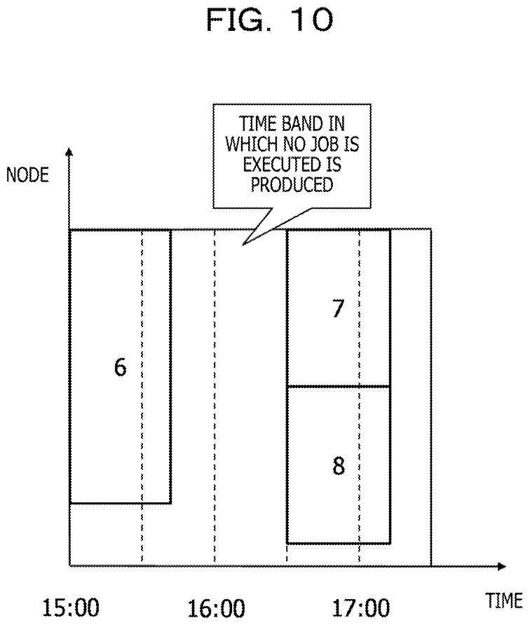

In this regard, for example, the information processing device 1 does not reschedule the execution timing of each job even when a job whose execution was completed earlier than originally planned has been produced, as illustrated in FIG. 10, which enables to mitigate the occurrence of a discrepancy between the actual execution timing of each job and the control schedule for the air conditioning equipment 4.

However, when the execution timing of each job is not rescheduled, the information processing device 1 is no longer allowed to efficiently execute jobs in the job execution device 3. Therefore, there are cases where the worker is not allowed to adopt administration without rescheduling the execution timing of each job.

Thus, in the present embodiment, based on the power consumption needed to execute a plurality of executed jobs that were executed in the past and the number of nodes used to execute the plurality of executed jobs, the information processing device 1 specifies power consumption needed when each number of nodes was employed to execute a job, for each of a plurality of numbers of nodes that are included in the numbers of nodes used to execute the plurality of executed jobs.

Then, among the plurality of numbers of nodes, the information processing device 1 specifies a particular number of nodes with which the specified power consumption is greater than a predetermined threshold value calculated based on the power consumption of a job execution device that executed the plurality of executed jobs. Moreover, the information processing device 1 specifies a particular job in which the number of nodes used for the execution is equal to or greater than the particular number of nodes, from among a plurality of jobs to be executed.

Thereafter, the information processing device 1 designates the execution timings of the plurality of jobs to be executed such that the execution timing of the specified particular job falls within a time band prescribed in advance.

For example, when scheduling the execution timing of each job, the information processing device 1 in the present embodiment designates the execution timing of a job having a large number of nodes used for the execution (hereinafter, referred to as a large-scale job) into a time band prescribed in advance (for example, a time band prescribed in advance by the worker). Then, the information processing device does not advance the execution timing of the large-scale job earlier even when the execution completion time of a job executed before the large-scale job is advanced earlier than originally planned.

This enables the information processing device 1 in the present embodiment to restrain the transition of the power consumption of the job execution device 3 during the execution of each job from being significantly changed from the prediction made in advance based on the execution timing of each job. Therefore, the information processing device 1 is enabled to mitigate the occurrence of a discrepancy between the actual execution timing of each job and the control schedule for the air conditioning equipment 4. Consequently, the information processing device 1 is allowed to properly adjust the temperature inside the building in which the job execution device 3 is deployed while permitting rescheduling of the execution timings of jobs other than the large-scale job.

[Hardware Configuration of information Processing System]

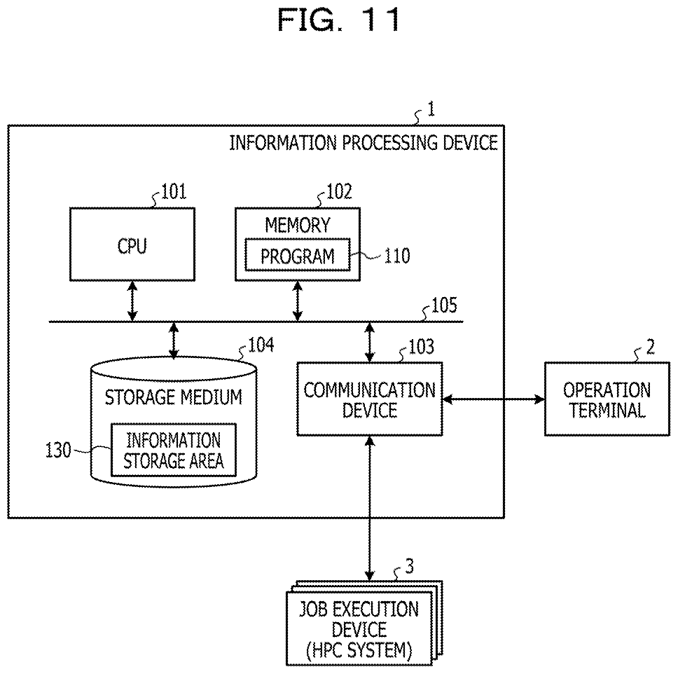

Next, a hardware configuration of the information processing system 10 will be described. FIG. 11 is a diagram explaining a hardware configuration of the information processing device 1.

As illustrated in FIG. 11, the information processing device 1 includes a central processing unit (CPU) 101, which is a processor, a memory 102, a communication device 103, and a storage medium 104. The respective units are interconnected via a bus 105.

The storage medium 104 has, for example, a program storage area (not illustrated) that stores a program 110 for performing a process of scheduling a job execution timing (hereinafter, also referred to as a job scheduling process). Furthermore, the storage medium 104 has, for example, a storage unit 130 that stores information used when the job scheduling process is performed (hereinafter, also referred to as an information storage area 130).

Note that the storage medium 104 can be, for example, a hard disk drive (HDD) or a solid state drive (SSD).

The CPU 101 executes the program 110 loaded from the storage medium 104 into the memory 102 to perform the job scheduling process.

Furthermore, the communication device 103 communicates with the operation terminal 2 and the job execution device 3 via a network (not illustrated), for example.

[Functions of information Processing System]

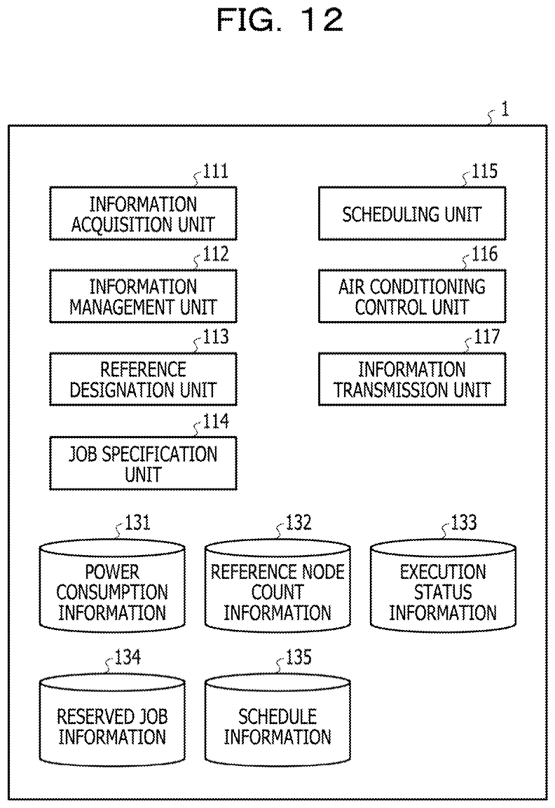

Next, the functions of the information processing system 10 will be described. FIG. 12 is a block diagram of the functions of the information processing device 1.

As illustrated in FIG. 12, for example, through organic collaboration between the hardware such as the CPU 101 and the memory 102 and the program 110, the information processing device 1 achieves an information acquisition unit 111, an information management unit 112, a reference designation unit 113, and a job specification unit 114. Furthermore, for example, through organic collaboration between the hardware such as the CPU 101 and the memory 102 and the program 110, the information processing device 1 achieves various functions including a scheduling unit 115, an air conditioning control unit 116, and an information transmission unit 117.

Moreover, as illustrated in FIG. 12, for example, the information processing device 1 stores, in the information storage area 130, power consumption information 131, reference node count information 132, execution status information 133, reserved job information 134, and schedule information 135.

The information acquisition unit 111 acquires, for example, the power consumption information 131 indicating the power consumption associated with the execution of each job in the job execution device 3, from the job execution device 3.

Furthermore, the information acquisition unit 111 receives, for example, a job to be executed, which has been transmitted from the operation terminal 2, and job information (not illustrate) including the maximum execution time and the number of execution nodes of each job.

Moreover, the information acquisition unit 111 acquires, for example, the execution status information 133 indicating the job execution status of each node constituting the job execution device 3, from each node.

The information management unit 112 stores, for example, the power consumption information 131 acquired from the job execution device 3 by the information acquisition unit 111 in the information storage area 130.

Furthermore, the information management unit 112 stores, for example, the job information (not illustrated) received by the information acquisition unit 111 in a queue.

Moreover, the information management unit 112 stores, for example, the execution status information 133 acquired by the information acquisition unit 111 in the information storage area 130.

Based on the power consumption information 131 needed to execute a plurality of jobs that were executed in the job execution device 3 in the past (hereinafter, also referred to as executed jobs) and the number of nodes used to execute the plurality of executed jobs, the reference designation unit 113 specifies the power consumption information 131 needed when each number of nodes was employed to execute a job, for each of a plurality of numbers of nodes that are included in the numbers of nodes used to execute the plurality of executed jobs.

Then, among the plurality of numbers of nodes that are included in the numbers of nodes used to execute the plurality of executed jobs, the reference designation unit 113 generates the reference node count information 132 indicating a number of nodes (hereinafter, also referred to as a particular number of nodes) with which the specified power consumption information 131 is greater than a predetermined threshold value calculated based on the power consumption information 131 of the job execution device 3 as a whole.

The job specification unit 114 specifies a job (hereinafter, also referred to as a particular job) in which the number of nodes used for the execution is equal to or greater than the particular number of nodes, from among a plurality of jobs stored in the queue (hereinafter, also referred to as execution target jobs).

The scheduling unit 115 designates the execution timings of the plurality of execution target jobs based on the job information acquired by the information acquisition unit 111.

For example, the scheduling unit 115 designates the execution timings of the plurality of execution target jobs such that the execution timing of the particular job specified by the job specification unit 114 falls within a time band prescribed in advance (for example, a time bane prescribed in advance by the worker).

The air conditioning control unit 116 designates the amount of cold heat to be output to the job execution device 3 by the air conditioning equipment 4 (the amount of cold heat to be output to the inside of the building) in time bands including the execution timings of the plurality of execution target jobs designated by the scheduling unit 115 such that, among the time bands including the execution timings of the plurality of execution target jobs, the amount of cold heat in a time band including the execution timing of the particular job specified by the job specification unit 114 is greater than the amount of cold heat in the other time bands.

The Information transmission unit 117 transmits the job received from the operation terminal 2 by the information acquisition unit 111 to the job execution device 3.

Furthermore, the information transmission unit 117 transmits the schedule information 135, which is information indicating the execution timing of each job, to the job execution device 3.

Moreover, the information transmission unit 117 transmits, for example, Information indicating the amount of cold heat designated by the air conditioning control unit 116, to the air conditioning equipment 4. The explanation of the reserved job information 134 will be described later.

### Outline of First Embodiment

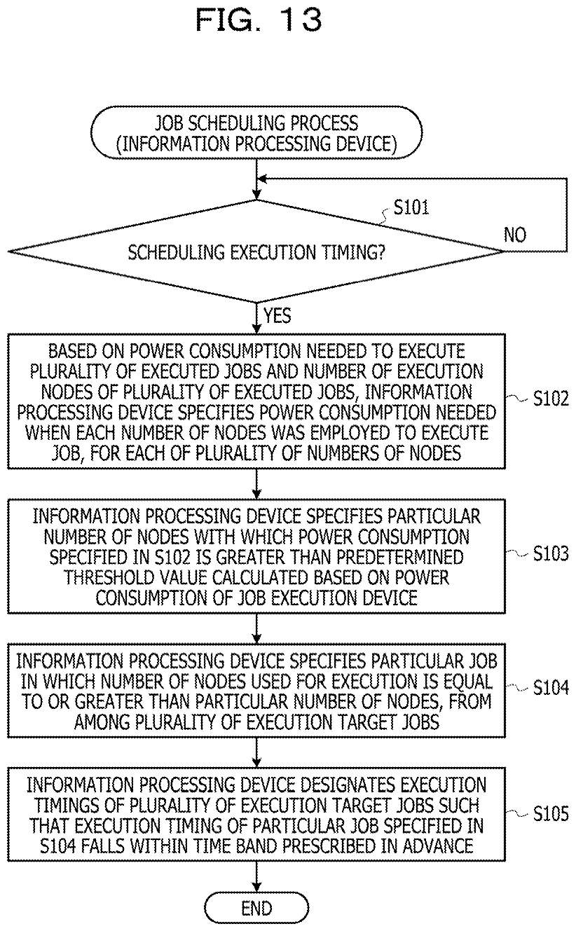

Next, an outline of a first embodiment will be described. FIG. 13 is a flowchart diagram explaining an outline of the job scheduling process according to the first embodiment.

As Illustrated in FIG. 13, the information processing device 1 waits until a scheduling execution timing comes (NO in S101). The scheduling execution timing can be, for example, a timing at which the job execution device 3 starts the job execution or a timing at which the job execution device 3 ends the job execution.

Then, when the scheduling execution timing comes (YES in S101), based on the power consumption needed to execute a plurality of executed jobs and the number of execution nodes of the plurality of executed jobs, the information processing device 1 specifies power consumption needed when each number of nodes was employed to execute a job, for each of a plurality of numbers of nodes (S102).

Subsequently, the information processing device 1 specifies a particular number of nodes with which the power consumption specified in the process in S102 is greater than a predetermined threshold value calculated based on the power consumption of the job execution device 3 (S103).

In detail, for example, the information processing device 1 specifies, as the particular number of nodes, a number of nodes with which the power consumption specified in the process in S102 is greater than the predetermined threshold value calculated based on the power consumption of the job execution device 3 but closest to the predetermined threshold value.

Moreover, the information processing device 1 specifies a particular job in which the number of nodes used for the execution is equal to or greater than the particular number of nodes, from among a plurality of execution target jobs (S104).

Thereafter, the information processing device 1 designates the execution timings of the plurality of execution target jobs such that the execution timing of the particular job specified in S104 falls within a time band prescribed in advance (S105).

For example, when scheduling the execution timing of each job, the information processing device 1 in the present embodiment fixes the execution timing of the large-scale job into a time band prescribed in advance (for example, a time band prescribed in advance by the worker). Then, the information processing device 1 does not advance the execution timing of the large-scale job earlier even when, for example, the execution completion time of a job executed before the large-scale job is advanced earlier than originally planned.

This enables the information processing device 1 in the present embodiment to restrain the transition of the power consumption of the job execution device 3 during the execution of each job from being significantly changed from the prediction made in advance based on the execution timing of each job. Therefore, the information processing device 1 is enabled to mitigate the occurrence of a discrepancy between the actual execution timing of each job and the control schedule for the air conditioning equipment 4. Consequently, the information processing device 1 is allowed to properly adjust the temperature inside the building in which the job execution device 3 is deployed while permitting rescheduling of the execution timings of jobs other than the large-scale job.

Furthermore, fixing the execution timing of the large-scale job in advance enables the information processing device 1 to suppress the amount of cold heat output from the air conditioning equipment 4 in a time band other than the execution timing of the large-scale job (the execution timing of a job other than the large-scale job). Therefore, the information processing device 1 is allowed to suppress the power consumption of the air conditioning equipment 4.

### Details of First Embodiment

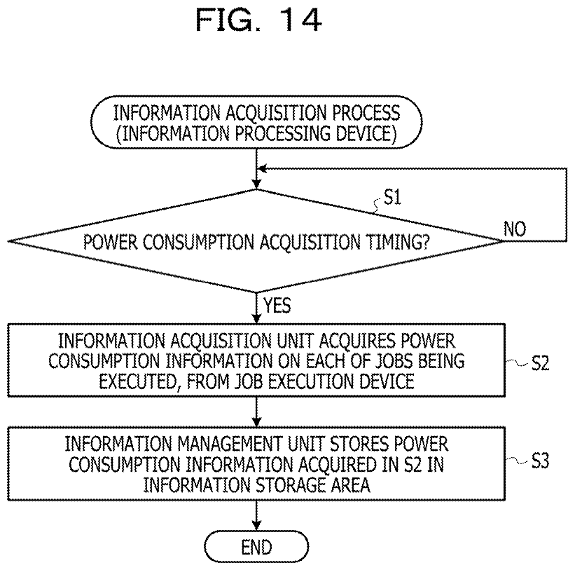

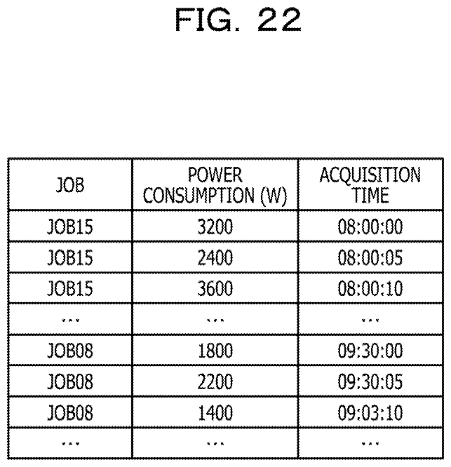

Next, the details of the first embodiment will be described. FIGS. 14 to 21 are flowchart diagrams explaining details of the job scheduling process according to the first embodiment. Furthermore, FIGS. 22 to 30 are diagrams explaining details of the job scheduling process according to the first embodiment.

[Information Acquisition Process]

First, as a part of the job scheduling process, a process of acquiring the power consumption information 131 (hereinafter, also referred to as an information acquisition process) will be described. FIG. 14 is a flowchart diagram explaining the information acquisition process.

As Illustrated in FIG. 14, the information acquisition unit 111 of the information processing device 1 waits until a power consumption acquisition timing comes (NO in S1). For example, the power consumption acquisition timing can be a periodic timing such as every five minutes.

Then, when the power consumption acquisition timing comes (YES in S1), the information acquisition unit 111 acquires the power consumption information 131 on each of the jobs being executed, from the job execution device 3 (S2).

Thereafter, the information management unit 112 of the information processing device 1 stores the power consumption information 131 acquired in the process in S2 in the information storage area 130 (S3).

For example, the information management unit 112 stores the power consumption information 131 acquired, for example, during the past one month in the information storage area 130. Hereinafter, a specific example of the power consumption information 131 accumulated in the information storage area 130 will be described.

[Specific Example of Power Consumption Information]

FIG. 22 is a diagram explaining a specific example of the power consumption information 131. For example, FIG. 22 is a diagram explaining a specific example of the power consumption information 131 accumulated in the information storage area 130.

The power consumption information 131 illustrated in FIG. 22 has, as items, “job” in which identification information on each job is set, “power consumption” in which the power consumption of each job is set, and “acquisition time” in which a time when each piece of information was acquired (a time when the process in S2 was performed) is set.

For example, in the power consumption information 131 illustrated in FIG. 22, “JOB15” is set as “job”, “3200 (W)” is set as “power consumption”, and “08:00:00” is set as “acquisition time” for the information in the first line.

Furthermore, in the power consumption information 131 illustrated in FIG. 22, “JOB15” is set as “job”, “2400 (W)” is set as “power consumption”, and “08:00:05” is set as “acquisition time” for the information in the second line.

Moreover, in the power consumption information 131 illustrated in FIG. 22, “JOB15” is set as “job”, “3600 (W)” is set as “power consumption”, and “08:00:10” is set as “acquisition time” for the information in the third line. The description of other information included in FIG. 22 will be omitted.

[Job Management Process]

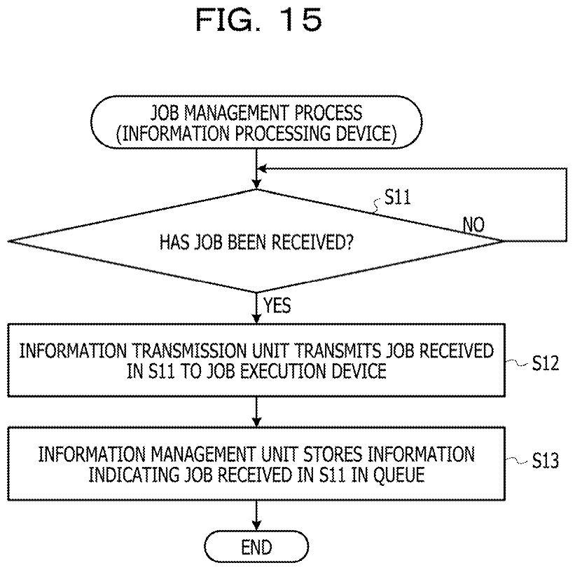

Next, as a part of the job scheduling process, a process of managing jobs (hereinafter, also referred to as a job management process) will be described. FIG. 15 is a flowchart diagram explaining the job management process.

As illustrated in FIG. 15, the information acquisition unit 111 waits until receiving, for example, a job (a job to be executed) transmitted from the operation terminal 2 (NO in S11). For example, the information acquisition unit 111 waits until receiving, for example, job information (not illustrated) including the maximum execution time and the number of execution nodes together with the job to be executed.

Then, when the job is received (YES in S11), the information transmission unit 117 of the information processing device 1 transmits the job received in the process in S11 to the job execution device 3 (S12).

Furthermore, in this case, for example, the information management unit 112 stores the job information (not illustrated) received in the process in S11 in the queue (S13).

[Reference Designation Process]

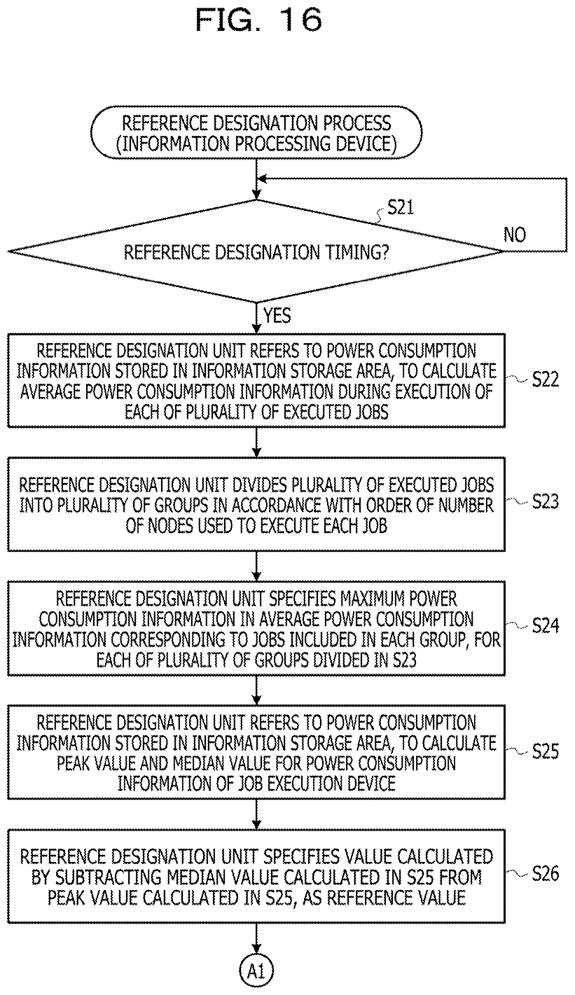

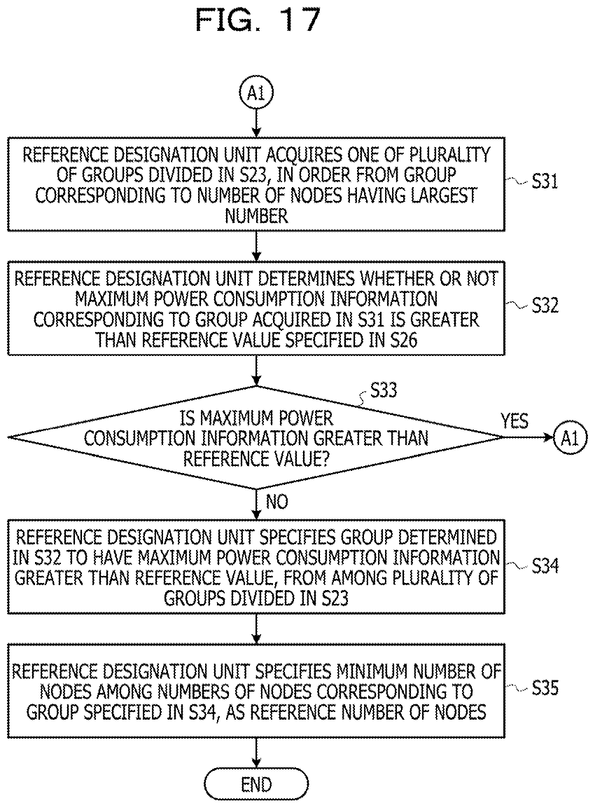

Next, as a part of the job scheduling process, a process of generating the reference node count information 132 (hereinafter, also referred to as a reference designation process) will be described. FIGS. 16 and 17 are flowchart diagrams explaining the reference designation process.

As Illustrated in FIG. 16, the reference designation unit 113 of the information processing device 1 waits until a reference designation timing comes (NO in S21). For example, the reference designation timing can be a periodic timing such as every one week.

Then, when the reference designation timing comes (YES in S21), the reference designation unit 113 refers to the power consumption information 131 stored in the information storage area 130, to calculate average power consumption information 131a during the execution of each of a plurality of executed jobs (S22). Hereinafter, a specific example of the average power consumption information 131a will be described.

[Specific Example of Average Power Consumption]

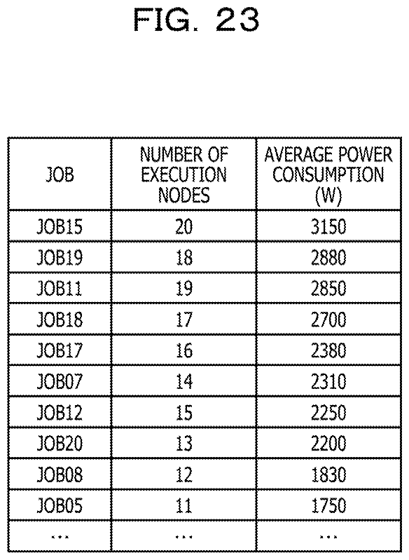

FIG. 23 is a diagram explaining a specific example of the average power consumption information 131a.

The average power consumption information 131a illustrated in FIG. 23 has, as items, “job” in which identification information on each job is set, “number of execution nodes” in which the number of nodes used to execute each job is set, and “average power consumption” In which an average value of power consumption during the execution of each job is set.

In detail, for example, among pieces of the power consumption information 131 illustrated in FIG. 22, when the average value of values set in “power consumption” of information in which “JOB15” is set in “job” has “3150 (W)”, the reference designation unit 113 sets “3150 (W)” in “average power consumption” of information in which “JOB15” is set in “job” (information in the first line), as illustrated in FIG. 23. Then, for example, when the number of nodes (number of execution nodes) used to execute a job whose identification information is “JOB15” is “20”, the reference designation unit 113 sets “20” in “number of execution nodes” of information in which “JOB15” is set in “job” (information in the first line), as illustrated in FIG. 23.

Furthermore, for example, among pieces of the power consumption information 131 illustrated in FIG. 22, when the average value of values set in “power consumption” of information in which “JOB19” Is set in “job” has “2880 (W)”, the reference designation unit 113 sets “2880 (W)” in “average power consumption” of information in which “JOB19” is set in “job” (information in the second line), as illustrated in FIG. 23. Then, for example, when the number of nodes used to execute “JOB19” is “18”, the reference designation unit 113 sets “18” in “number of execution nodes” of information in which “JOB19” is set in “job” (information in the second line), as illustrated in FIG. 23. The description of other information included in FIG. 23 will be omitted.

Returning to FIG. 16, the reference designation unit 113 divides the plurality of executed jobs into a plurality of groups in accordance with the order of the number of nodes used to execute each job (S23). In detail, for example, the reference designation unit 113 generates group information 131b indicating results of dividing the plurality of executed jobs. Hereinafter, a specific example of the group information 131b will be described.

[Specific Example of Group Information]

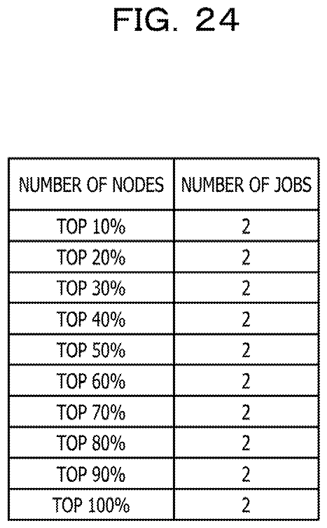

FIG. 24 is a diagram explaining a specific example of the group information 131b.

The group information 131b Illustrated in FIG. 24 has, as items, “number of nodes” in which each range for the number of nodes is set, and “number of jobs” in which a job executed by employing the number of nodes contained in each range is set.

In detail, for example, when the number of groups obtained by dividing the executed jobs in the process in S23 is “10”, and the number of jobs whose information is included in the average power consumption information 131a described with reference to FIG. 23 is “20”, the reference designation unit 113 specifies “2” as the number of jobs included in each group.

Therefore, for example, as illustrated in the first line in FIG. 24, the reference designation unit 113 sets information in which “top 10%” is set in “number of nodes” and “2” is set in “number of jobs”, as information corresponding to the first group.

This means that, for example, the information illustrated in the first line in FIG. 24 indicates that, among jobs whose information is included in the average power consumption information 131a described with reference to FIG. 23, two jobs (JOB15 and JOB11) whose values set in “number of nodes” have magnitudes ranked within the top 10% are the jobs included in the first group.

Furthermore, for example, as illustrated in the second line in FIG. 24, the reference designation unit 113 sets information in which “top 20%” is set in “number of nodes” and “2” is set in “number of jobs” (information in the second line), as information corresponding to the second group.

This means that, for example, the information illustrated in the second line in FIG. 24 indicates that, among jobs whose information is included in the average power consumption information 131a described with reference to FIG. 23, two jobs (JOB19 and JOB18) whose values set in “number of nodes” have magnitudes ranked between the top 10% and the top 20% are the jobs included in the second group. The description of other information included in FIG. 24 will be omitted.

Returning to FIG. 16, the reference designation unit 113 specifies maximum power consumption information 131c in the average power consumption information 131a corresponding to the jobs included in each group, for each of the plurality of groups divided in the process in S23 (S24). Hereinafter, a specific example of the maximum power consumption information 131c will be described.

[Specific Example of Maximum Power Consumption Information]

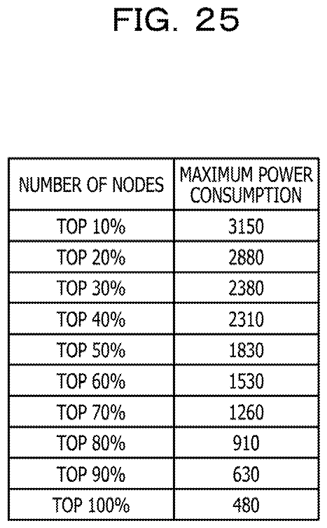

FIG. 25 is a diagram explaining a specific example of the maximum power consumption information 131c.

The maximum power consumption information 131c Illustrated in FIG. 25 has, as items, “number of nodes” in which each range for the number of nodes is set, and “maximum power consumption” in which the maximum power consumption among the power consumptions of the jobs executed by employing the number of nodes included in each range is set.

In detail, for example, when jobs assigned to the first group in the process in S23 are “JOB15” and “JOB11”, the reference designation unit 113 refers to the average power consumption information 131a described with reference to FIG. 23, to specify “3150 (W)” as the maximum power consumption among “3150 (W)” and “2850 (W)”, which are “power consumptions” corresponding to “JOB15” and “JOB11”, respectively. Then, as illustrated in FIG. 25, the reference designation unit 113 sets “3150 (W)” in “maximum power consumption information” of information in which “top 10%” is set in “number of nodes” (information in the first line).

Furthermore, for example, when jobs assigned to the second group in the process in S23 are “JOB19” and “JOB18”, the reference designation unit 113 refers to the average power consumption information 131a described with reference to FIG. 23, to specify “2880 (W)” as the maximum power consumption among “2880 (W)” and “2700 (W)”, which are “power consumptions” corresponding to “JOB19” and “JOB18”, respectively. Then, as illustrated in FIG. 25, the reference designation unit 113 sets “2880 (W)” In “maximum power consumption information” of information in which “top 20%” is set in “number of nodes” (information in the second line). The description of other information included in FIG. 25 will be omitted.

Returning to FIG. 16, the reference designation unit 113 refers to the power consumption information 131 stored in the information storage area 130, to calculate a peak value and a median value for the power consumption information 131 of the job execution device 3 (S25).

Then, the reference designation unit 113 specifies a value calculated by subtracting the median value calculated in the process in S25 from the peak value calculated in the process in S25, as a reference value (S26).

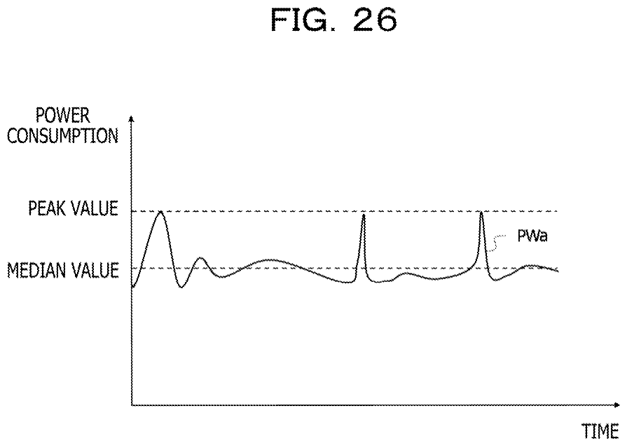

In detail, for example, for each acquisition timing of the power consumption information 131 in the process in S1, the reference designation unit 113 calculates a total value of the power consumption information 131 acquired at each timing, as the power consumption information 131 of the job execution device 3 as a whole at each timing. Then, as illustrated in FIG. 26, for example, the reference designation unit 113 generates time-series data PWa indicating the transition of the calculated power consumption information 131 of the job execution device 3. Thereafter, the reference designation unit 113 calculates the reference value by subtracting the median value from the peak value in the time-series data PWa illustrated in FIG. 26, for example.

Subsequently, as illustrated in FIG. 17, the reference designation unit 113 acquires one of the plurality of groups divided in the process in S23, in the order from a group corresponding to the number of nodes having the largest number (S31).

For example, the reference designation unit 113 first acquires the first group to which “JOB15” and “JOB11” are assigned in the process in S23.

Moreover, the reference designation unit 113 determines whether or not the maximum power consumption information 131c corresponding to the group acquired in the process in S31 is greater than the reference value specified in the process in S26 (S32).

As a result, when it is determined that the maximum power consumption information 131c corresponding to the group acquired in the process in S31 is greater than the reference value specified in the process in S26 (YES in S33), the reference designation unit 113 performs the processes in S31 and the following step again.

On the other hand, when it is determined that the maximum power consumption information 131c corresponding to the group acquired in the process in S31 is not greater than the reference value specified in the process in S26 (NO in S33), the reference designation unit 113 specifies a group determined in the process in S32 to have the maximum power consumption information 131c greater than the reference value, from among the plurality of groups divided in the process in S23 (S34).

Then, in this case, the reference designation unit 113 specifies the minimum number of nodes among the numbers of nodes corresponding to the group specified in the process in S34, as a reference number of nodes (S35).

In detail, for example, in “maximum power consumption” in the maximum power consumption information 131c described with reference to FIG. 25, for example, “3150 (W)”, “2880 (W)” and “2380 (W)” are set as “maximum power consumption” of information whose “number of nodes” has “top 10%”, “top 20%”, and “top 30%”, respectively. Furthermore, in the average power consumption information 131a described with reference to FIG. 23, for example, the number of nodes corresponding to the top 10% includes “20” and “19”, and the number of nodes corresponding to from the top 10% to the top 20% includes “18” and “17”. Therefore, for example, when the reference value specified in the process in S26 is “2500 (W)”, the reference designation unit 113 specifies, as the reference number of nodes, for example, “17”, which is the smallest number of nodes among “20” and “19” as the numbers of nodes corresponding to “top 10%” and “18” and “17” as the numbers of nodes corresponding to “top 20%”.

This means that it can be deemed that the power consumption included in the maximum power consumption information 131c calculated in the process in S24 is information indicating, for example, the maximum displacement in the power consumption during the execution of each job included in each group (the power consumption of the job execution device 3 as a whole). Furthermore, it can be deemed that the reference value specified in the process in S25 is information indicating, for example, the maximum displacement in the past (for example, the past one month) in the power consumption of the job execution device 3 as a whole.

Therefore, it can be deemed that a job executed by employing the number of nodes corresponding to a group deemed to have the power consumption included in the maximum power consumption information 131c greater than the reference value is a large-scale job that is likely to consume electric power exceeding the past maximum displacement in the power consumption of the job execution device 3.

Accordingly, the reference designation unit 113 specifies, for example, the minimum number of nodes corresponding to the group deemed to have the power consumption included in the maximum power consumption information 131c greater than the reference value, as the reference number of nodes used as a reference when it is verified whether or not each job is deemed as a large-scale job.

[Reservation Management Process]

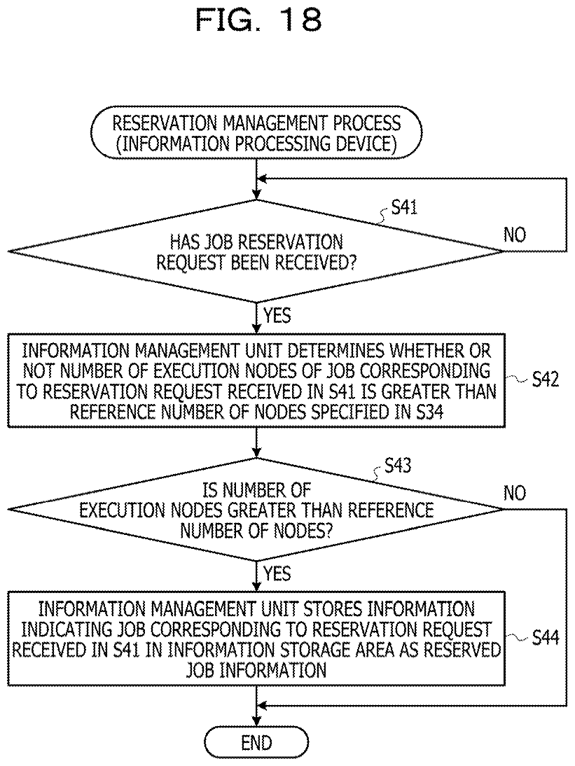

Next, as a part of the job scheduling process, a process of generating the reserved job information 134, which is information indicating a job whose execution timing is reserved, (hereinafter, also referred to as a reservation management process) will be described. FIG. 18 is a flowchart diagram explaining the reservation management process.

As illustrated in FIG. 18, the information acquisition unit 111 waits until receiving a job reservation request (NO in S41). The job reservation request is, for example, a request transmitted by the worker via the operation terminal 2, which is a request for reserving the job execution timing.

Then, when the job reservation request is received (YES in S41), the information management unit 112 determines whether or not the number of execution nodes of a job corresponding to the reservation request received in the process in S41 is greater than the reference number of nodes specified in the process in S34 (S42).

For example, the information management unit 112 refers to the job information (not illustrated) stored in the information storage area 130 to determine whether or not the number of execution nodes of the job for which the reservation request has been received in the process in S41 is greater than the reference number of nodes specified in the process in S34.

As a result, when it is determined that the number of execution nodes of the job corresponding to the reservation request received in the process in S41 is greater than the reference number of nodes specified in the process in S34 (YES in S43), the information management unit 112 stores information indicating the job corresponding to the reservation request received in the process in S41 in the information storage area 130 as the reserved job information 134.

On the other hand, when it is determined that the number of execution nodes of the job corresponding to the reservation request received in the process in S41 is not greater than the reference number of nodes specified in the process in S34 (NO in S43), the information management unit 112 does not execute the process in S44.

This means that, for example, the information management unit 112 stores information indicating the job corresponding to the reservation request received in the process in S41 in the information storage area 130 as the reserved job information 134 only when the reservation request received in the process in S41 is a reservation request corresponding to the large-scale job. Hereinafter, a specific example of the reserved job information 134 will be described.

[Specific Example of Reserved Job Information]

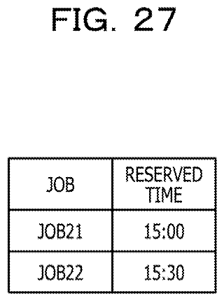

FIG. 27 is a diagram explaining a specific example of the reserved job information 134.

The reserved job information 134 illustrated in FIG. 27 has, as items, “job” in which identification information on each job is set, and “reserved time” in which the reserved time for the execution timing of each job is set.

For example, in the reserved job information 134 illustrated in FIG. 27, “JOB21” is set as “job” and “15:00” is set as “reserved time” in the information in the first line.

Furthermore, in the reserved job information 134 illustrated in FIG. 27, “JOB22” is set as “job” and “15:30” is set as “reserved time” in the information in the second line.

[Main Process of Job Scheduling Process]

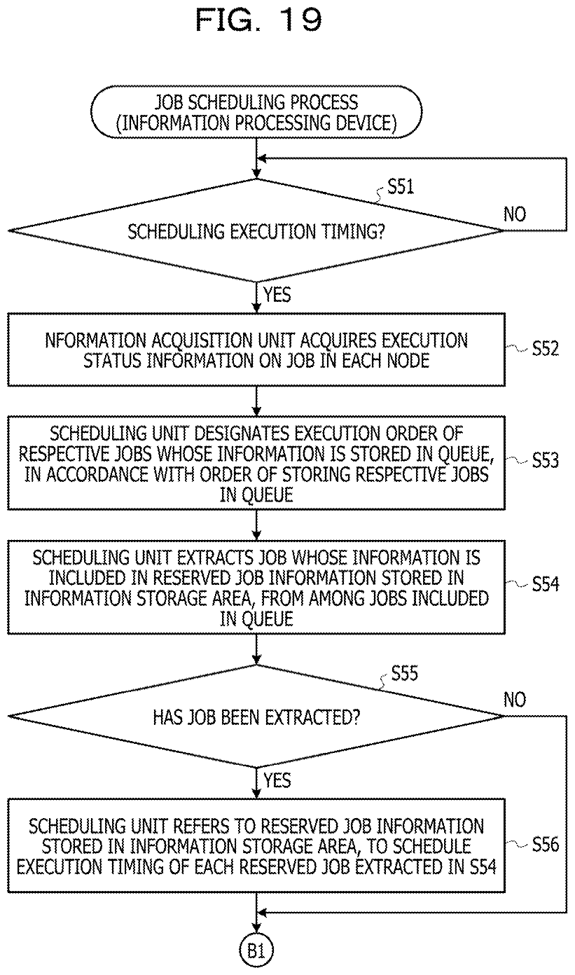

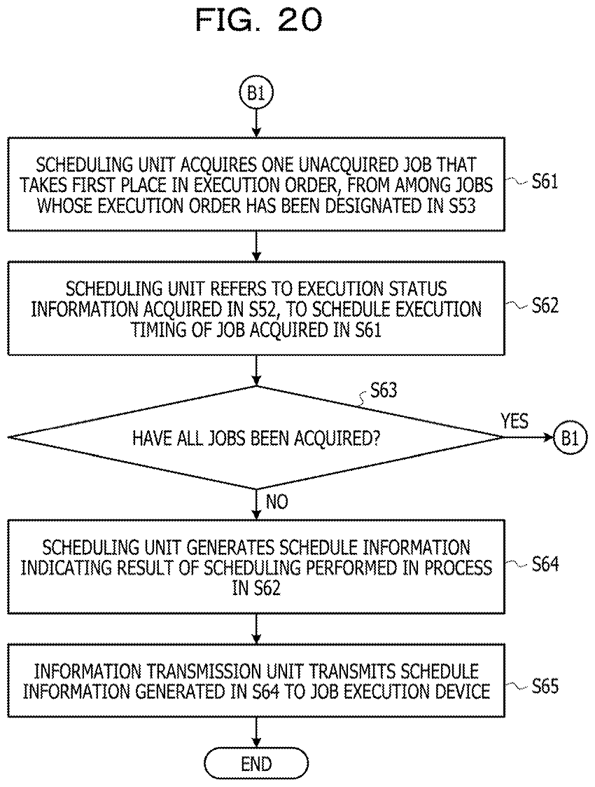

Next, a main process of the job scheduling process will be described. FIGS. 19 and 20 are flowchart diagrams explaining the main process of the job scheduling process.

As illustrated in FIG. 19, the information acquisition unit 111 waits until the scheduling execution timing comes (NO in S51). The scheduling execution timing can be, for example, a timing at which the job execution device 3 starts the job execution or a timing at which the job execution device 3 ends the job execution.

Then, when the scheduling execution timing comes (YES in S51), the information acquisition unit 111 acquires the execution status information 133 on a job in each node (S52). Hereinafter, a specific example of the execution status information 133 on a job will be described.

[Specific Example of Execution Status Information]

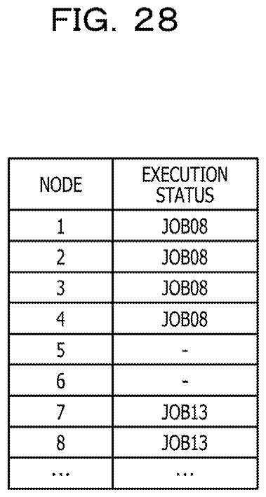

FIG. 28 is a diagram explaining a specific example of the execution status information 133.

The execution status information 133 illustrated in FIG. 28 has, as items, “node” in which identification information on each node is set, and “execution status” in which identification information on a job being executed in each node is set.

In detail, in the execution status information 133 illustrated in FIG. 28, for example, “1” is set as “node” and “JOB08” is set as “execution status” in the information in the first line. Furthermore, in the execution status information 133 illustrated in FIG. 28, for example, “2” Is set as “node” and “JOB08” Is set as “execution status” in the information in the second line.

This means that the execution status information 133 illustrated in FIG. 28 indicates that JOB08 is being executed across a plurality of nodes. The description of other information included in FIG. 28 will be omitted.

Returning to FIG. 19, the scheduling unit 115 designates, for example, an execution order of respective jobs whose information is stored in the queue, in accordance with the order of storing the respective jobs in the queue (S53).

Then, the scheduling unit 115 extracts a job whose information is included in the reserved job information 134 stored in the information storage area 130, from among the jobs included in the queue (S54).

As a result, when a job is extracted in the process in S54 (YES in S55), the scheduling unit 115 refers to the reserved job information 134 stored in the information storage area 130, to schedule the execution timing of the job extracted in the process in S54.

On the other hand, when no job is extracted in the process in S54 (NO in S55), the scheduling unit 115 does not perform the process in S56.

This means that the scheduling unit 115 designates the execution timing of a job (large-scale job) whose information is Included in the reserved job information 134 with priority over other jobs.

Then, as illustrated in FIG. 20, the scheduling unit 115 acquires one unacquired job that takes the first place in the execution order, from among the jobs whose execution order has been designated in the process in S53 (S61).

Subsequently, the scheduling unit 115 refers to the execution status information 133 acquired in the process in S52, to schedule the execution timing of the job acquired in the process in S61 (S62).

In detail, for example, the scheduling unit 115 refers to the execution status information 133 described with reference to FIG. 28, and determines that JOB08 is being executed on a plurality of nodes including a node whose identification information is “1”. Furthermore, for example, the scheduling unit 115 refers to the execution status information 133 described with reference to FIG. 28, and determines that JOB13 is being executed on a plurality of nodes including a node whose identification information is “7”.

Then, the scheduling unit 115 refers to the maximum execution time included in the job information (not illustrated) for each of the jobs including JOB08 and JOB13 being executed, and calculates a predicted time expected to end the execution of all of the jobs. Moreover, the scheduling unit 115 specifies a predicted time (hereinafter, also referred to as a schedulable time) in which unexecuted jobs can be scheduled in each node, in the predicted time expected to end the execution of all of the jobs. Thereafter, as in the case described with reference to FIGS. 5 and 6, for example, the scheduling unit 115 schedules the job acquired in the process in S61 in a time within the schedulable time during which the job acquired in the process in S61 can be executed.

Thereafter, the scheduling unit 115 determines whether or not all the jobs have been acquired in the process in S61 (S63).

As a result, when it is determined that all the jobs have not been acquired in the process in S61 (NO in S63), the scheduling unit 115 performs the process in S61 and the following step again.

On the other hand, when it is determined that all the jobs have been acquired in the process in S61 (YES in S63), the scheduling unit 115 generates the schedule information 135 indicating the result of the scheduling performed in the process in S62 (S64).

This enables the scheduling unit 115 to perform job scheduling in which the designation of the execution timing for the large-scale job is prioritized over the designation of the execution timing of other jobs.

Then, the information transmission unit 117 transmits the schedule information 135 generated in the process in S64 to the job execution device 3 (S65). Hereinafter, a specific example of the schedule information 135 will be described.

[Specific Example of Schedule Information]

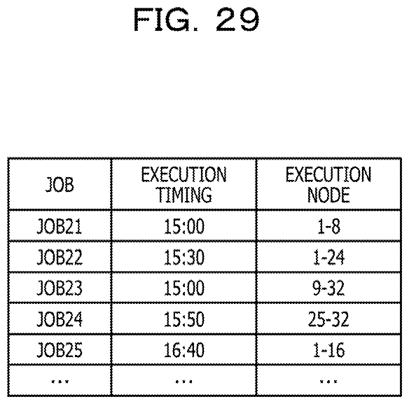

FIG. 29 is a diagram explaining a specific example of the schedule information 135.

The schedule information 135 illustrated in FIG. 29 has, as items, “job” in which identification information on each job is set, “execution timing” in which the execution timing of each job is set, and “execution node” in which identification information on the execution node of each job is set.

For example, in the schedule information 135 illustrated in FIG. 29, “15:00” is set as “execution timing”, and “1-8” is set as “execution node” for information in which “job” has “JOB21” (information in the first line).

Furthermore, in the schedule information 135 illustrated in FIG. 29, “15:30” is set as “execution timing”, and “1-24” Is set as “execution node” for information in which “job” has “JOB22” (information in the second line). The description of other information included in FIG. 29 will be omitted.

[Air Conditioning Control Process]

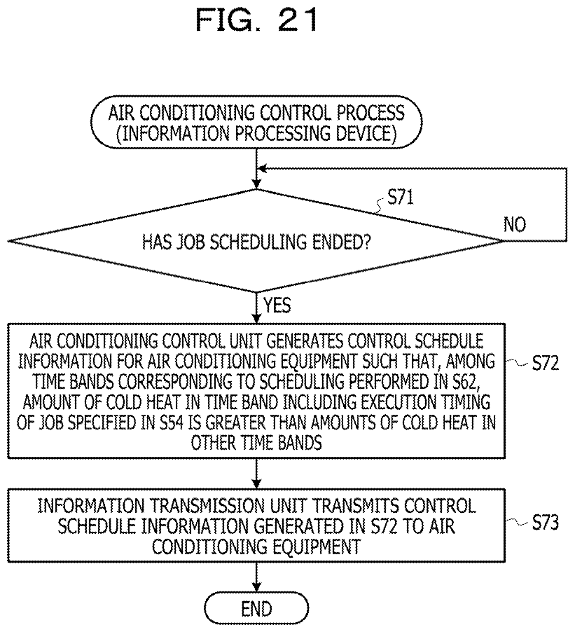

Next, as a part of the job scheduling process, a process of controlling the air conditioning equipment 4 (hereinafter, also referred to as an air conditioning control process) will be described. FIG. 21 is a flowchart diagram explaining the air conditioning control process.

As illustrated in FIG. 21, the air conditioning control unit 116 of the information processing device 1 waits until the job scheduling ends (NO in S71). For example, the air conditioning control unit 116 waits until, for example, the main process of the job scheduling process described with reference to FIGS. 19 and 20 ends.

Then, when the job scheduling ends (YES in S71), the air conditioning control unit 116 generates information indicating the control schedule for the air conditioning equipment 4 (hereinafter, also referred to as control schedule information) such that, among time bands corresponding to the scheduling performed in the process in S62, the amount of cold heat in a time band including the execution timing of the job specified in the process in S54 is greater than the amounts of cold heat in other time bands (S72).

In detail, for example, the air conditioning control unit 116 refers to the power consumption information 131 stored in the information storage area 130, to specify the amount of power consumption needed to execute a job corresponding to the same number of nodes as the job specified in the process in S54. Then, the air conditioning control unit 116 generates the control schedule information for the air conditioning equipment 4 such that, for example, the amount of cold heat in the time band including the execution timing of the job specified in the process in S54 matches the amount of power consumption (amount of heat) expected to execute the job specified in the process in S54.

Note that the air conditioning control unit 116 may acquire the amount of power consumption (amount of heat) expected to execute the job specified in the process in S54 by using a machine learning model that predicts the amount of power consumption of each job.

Thereafter, the information transmission unit 117 transmits the control schedule information generated in the process in S72 to the air conditioning equipment 4 (S73). Hereinafter, a specific example of the control schedule for the air conditioning equipment 4 according to the present embodiment will be described.

[Specific Example of Control Schedule for Air Conditioning Equipment]

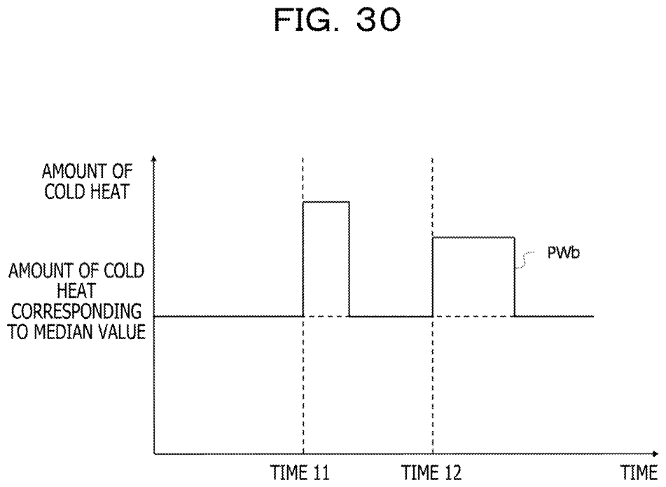

FIG. 30 is a diagram explaining the control schedule for the air conditioning equipment. The horizontal axis and the vertical axis in the example illustrated in FIG. 30 indicate the time when each job is executed and the amount of cold heat output by the air conditioning equipment 4, respectively.

In detail, time-series data (control schedule) PWb illustrated in FIG. 30 indicates that the power consumption information 131 in the job execution device 3 becomes large, for example, at a timing (time 11) when “JOB21” is to be executed and at a timing (time 12) when “JOB22” is to be executed, both of which are large-scale jobs whose information is included in the reserved job information 134 described with reference to FIG. 27.

Then, in this case, as illustrated in the time-series data PWb in FIG. 30, the information processing device 1 designates the amount of cold heat in time bands from the time 11 until the execution time (maximum execution time) of “JOB21” elapses, as an amount of cold heat (hereinafter, also referred to as a first amount of cold heat) that can suppress the temperature rise inside the building while “JOB21” is executed. Furthermore, as illustrated in the time-series data PWb in FIG. 30, the information processing device 1 designates the amount of cold heat in time bands from the time 12 until the execution time (maximum execution time) of “JOB22” elapses, as an amount of cold heat (hereinafter, also referred to as a second amount of cold heat) that can suppress the temperature rise inside the building while “JOB22” is executed. Moreover, as illustrated in the time-series data PWb in FIG. 30, the information processing device 1 designates the amount of cold heat in time bands other than the time bands from the time 11 until the execution time of “JOB21” elapses and the time bands from the time 12 until the execution time of “JOB22” elapses, as an amount of cold head (an amount of cold heat smaller than the first amount of cold heat and the second amount of cold heat) that can suppress the temperature rise inside the building when the power consumption of the job execution device 3 coincides with the median value (the median value calculated in the process in S25).

This enables the air conditioning equipment 4 to output the amount of cold heat expected at the execution timing of the large-scale job, for example, by altering the setting of the amount of cold heat in accordance with the time-series data PWb illustrated in FIG. 30.

Furthermore, the air conditioning equipment 4 no longer needs to regularly output the amount of cold heat corresponding to the execution timing of the large-scale job, for example, by altering the setting of the amount of cold heat in accordance with the time-series data PWb Illustrated in FIG. 30. Therefore, the information processing device 1 is allowed to suppress the power consumption of the air conditioning equipment 4.

Moreover, even when the job is rescheduled at a timing when the alteration of the control schedule for the air conditioning equipment 4 is not allowed, the information processing device 1 is enabled to mitigate the occurrence of a discrepancy between the actual execution timing of each job and the control schedule for the air conditioning equipment 4.

As described above, in the present embodiment, based on the power consumption needed to execute a plurality of executed jobs that were executed in the past and the number of nodes used to execute the plurality of executed jobs, the information processing device 1 specifies power consumption needed when each number of nodes was employed to execute a job, for each of a plurality of numbers of nodes that are included in the numbers of nodes used to execute the plurality of executed jobs.

Then, among the plurality of numbers of nodes, the information processing device 1 specifies a particular number of nodes with which the specified power consumption is greater than a predetermined threshold value calculated based on the power consumption of a job execution device that executed the plurality of executed jobs. Moreover, the information processing device 1 specifies a particular job in which the number of nodes used for the execution is equal to or greater than the particular number of nodes, from among a plurality of jobs to be executed.

Thereafter, the information processing device 1 designates the execution timings of the plurality of jobs to be executed such that the execution timing of the specified particular job falls within a time band prescribed in advance.

For example, when scheduling the execution timing of each job, the information processing device 1 in the present embodiment fixes the execution timing of the large-scale job into a time band prescribed in advance (for example, a time band prescribed in advance by the worker). Then, the information processing device 1 does not advance the execution timing of the large-scale job earlier even when, for example, the execution completion time of a job executed before the large-scale job is advanced earlier than originally planned.

This enables the information processing device 1 in the present embodiment to restrain the transition of the power consumption of the job execution device 3 during the execution of each job from being significantly changed from the prediction made in advance based on the execution timing of each job. Therefore, the information processing device 1 is enabled to mitigate the occurrence of a discrepancy between the actual execution timing of each job and the control schedule for the air conditioning equipment 4. Consequently, the information processing device 1 is allowed to properly adjust the temperature inside the building in which the job execution device 3 is deployed while permitting rescheduling of the execution timings of jobs other than the large-scale job.

Furthermore, fixing the execution timing of the large-scale job in advance enables the information processing device 1 to suppress the amount of cold heat output from the air conditioning equipment 4 in a time band other than the execution timing of the large-scale job (the execution timing of a job other than the large-scale job). Therefore, the information processing device 1 is allowed to suppress the power consumption of the air conditioning equipment 4.

The above embodiments can be summarized as in the following supplementary notes.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
identifying a first power consumption needed to execute a plurality of first jobs executed in a past and a plurality of nodes used to execute the plurality of first jobs;
identifying a second power consumption needed for each of the plurality of nodes used to execute the plurality of first jobs to execute a job, based on the first power consumption and the plurality of nodes;
identifying a first node of which the second power consumption is greater than a predetermined threshold value, from among the plurality of nodes;
identifying a third job in which a number of nodes used for execution is equal to or greater than a number of the first nodes, from among a plurality of second jobs to be executed; and
setting a timing of executing the third job to a predetermined time.

2. The non-transitory computer-readable storage medium according to claim 1, wherein the process comprising:
dividing the plurality of first jobs into a plurality of groups in accordance with an order of a number of nodes used to execute each job;
specifying a particular power consumption that is included in power consumptions used to execute jobs included in each group, for each of the plurality of groups that have been divided;
specifying a particular group that has the particular power consumption greater than the predetermined threshold value but closest to the predetermined threshold value, from among the plurality of groups; and
specifying, as the third job, a job executed by nodes, a number of which is equal to or greater than a minimum number of nodes included in the particular group, from among the plurality of second jobs.

3. The non-transitory computer-readable storage medium according to claim 2, wherein the process comprising:
specifying a maximum power consumption of power consumptions used to execute jobs included in each group, as the particular power consumption, for each of the plurality of groups.

4. The non-transitory computer-readable storage medium according to claim 1, wherein the process comprising:
calculating the predetermined threshold value based on a median value within a predetermined time of a power consumption of a job execution device that executed the first jobs.

5. The non-transitory computer-readable storage medium according to claim 4, wherein the process comprising:
calculating a value calculated by subtracting the median value from a peak value within the predetermined time of the power consumption of the job execution device, as the predetermined threshold value.

6. The non-transitory computer-readable storage medium according to claim 1, wherein the process comprising:
designating an amount of cold heat to be output to a job execution device in time bands that include execution timings of the second jobs such that, among the time bands that include the execution timings of the second jobs, an amount of cold heat in a time band that includes an execution timing of the third job is greater than amounts of cold heat in the other time bands.

7. A job scheduling device, comprising:
a memory; and
a processor coupled to the memory and the processor configured to:
identify a first power consumption needed to execute a plurality of first jobs executed in a past and a plurality of nodes used to execute the plurality of first jobs,
identify a second power consumption needed for each of the plurality of nodes used to execute the plurality of first jobs to execute a job, based on the first power consumption and the plurality of nodes,
identify a first node of which the second power consumption is greater than a predetermined threshold value, from among the plurality of nodes,
identify a third job in which a number of nodes used for execution is equal to or greater than a number of the first nodes, from among a plurality of second jobs to be executed, and
set a timing of executing the third job to a predetermined time.

8. The job scheduling device according to claim 7, wherein the processor configured to:
divide the plurality of first jobs into a plurality of groups in accordance with an order of a number of nodes used to execute each job;
specify a particular power consumption that is Included in power consumptions used to execute jobs included in each group, for each of the plurality of groups that have been divided;
specify a particular group that has the particular power consumption greater than the predetermined threshold value but closest to the predetermined threshold value, from among the plurality of groups; and
specify, as the third job, a job executed by nodes, a number of which is equal to or greater than a minimum number of nodes included in the particular group, from among the plurality of second jobs.

9. The job scheduling device according to claim 8, wherein the processor configured to
specify a maximum power consumption of power consumptions used to execute jobs included in each group, as the particular power consumption, for each of the plurality of groups.

10. The job scheduling device according to claim 7, wherein the processor configured to
calculate the predetermined threshold value based on a median value within a predetermined time of a power consumption of a job execution device that executed the first jobs.

11. The job scheduling device according to claim 10, wherein the processor configured to
calculate a value calculated by subtracting the median value from a peak value within the predetermined time of the power consumption of the job execution device, as the predetermined threshold value.

12. The job scheduling device according to claim 10, wherein the processor configured to
designate an amount of cold heat to be output to a job execution device in time bands that include execution timings of the second jobs such that, among the time bands that include the execution timings of the second jobs, an amount of cold heat in a time band that includes an execution timing of the third job is greater than amounts of cold heat in the other time bands.

13. A job scheduling method executed by a computer, the method comprising:
identifying a first power consumption needed to execute a plurality of first jobs executed in a past and a plurality of nodes used to execute the plurality of first jobs;
identifying a second power consumption needed for each of the plurality of nodes used to execute the plurality of first jobs to execute a job, based on the first power consumption and the plurality of nodes;
identifying a first node of which the second power consumption is greater than a predetermined threshold value, from among the plurality of nodes;
identifying a third job in which a number of nodes used for execution is equal to or greater than a number of the first nodes, from among a plurality of second jobs to be executed; and
setting a timing of executing the third job to a predetermined time.
